(19) United States
(12) Patent Application Publication
(10) Pub. No.: US 2026/0162040 A1
(43) Pub. Date: Jun. 11, 2026

(54) COMPLIANCE PROGRESS TRACKING AND DOCUMENT GENERATION METHOD

(71) Applicant: Christian Khoury, Toronto (CA)

(72) Inventor: Christian Khoury, Toronto (CA)

(21) Appl. No.: 18/976,486

(22) Filed: Dec. 11, 2024

(51) Int. Cl. G06Q 10/0635

(52) U.S. Cl. CPC G06Q 10/0635

(57) ABSTRACT

A method for providing automated tracking of fulfillment of controls for compliance frameworks wherein the method of the present invention is facilitated by a software application. The method of the present application provides generation of assessment reports for all of the compliance frameworks that a user organization must fulfill the requirements thereof. The method leverages a questionnaire set to obtain information about the user organization in conjunction with any available documents such as but not limited to security and risk assessments. Utilizing the information input about the user organization the software application will generate the required controls for the selected compliance framework. Tracking of the fulfillment of the controls for each compliance framework is performed and any redundant controls across multiple frameworks are automatically tracked and progress thereof updated. The method will provide suggested evidence documents and generation thereof for controls as required by the user.

### FIELD OF THE INVENTION

The present invention relates generally to compliance programs, processes and documentation generation, more specifically but not by way of limitation, a system that automates the generation of compliance controls and frameworks for regulatory requirements such as but not limited to SOC2, NIST, CSF and ISO 27001 wherein the present invention optimizes audit workflows to enable accurate and scalable compliance processes and adherence thereto.

### BACKGROUND

In today's rapidly evolving business environment, regulatory compliance has become a cornerstone of organizational trust, operational efficiency, and risk mitigation. Frameworks like SOC 2 (Service Organization Control 2) and ISO (International Organization for Standardization) standards provide structured approaches for ensuring security, integrity, and reliability in business operations. Generating and maintaining compliance documents and processes is not merely a legal or contractual obligation but a strategic imperative that underscores an organization's commitment to excellence. Compliance documents and processes serve as the backbone for demonstrating an organization's commitment to upholding stringent security, privacy, and operational standards. Certifications like SOC 2 and ISO 27001, which focus on information security management, are increasingly viewed as benchmarks of reliability by clients, stakeholders, and partners. For example, achieving SOC 2 compliance assures customers that an organization has implemented robust controls to protect sensitive data. This is especially vital in industries like technology, finance, and healthcare, where data breaches can lead to severe reputational damage. Similarly, ISO certifications offer international recognition, providing businesses with a competitive edge in global markets. The presence of well-documented compliance frameworks signals professionalism and helps foster long-term trust.

Regulatory compliance frameworks like SOC 2 and ISO are designed to identify, address, and mitigate risks systematically. Organizations generate compliance documents to outline protocols, procedures, and contingency plans, ensuring they can adapt to emerging threats. By documenting processes, businesses can maintain consistent practices, avoid operational oversights, and reduce vulnerabilities. For instance, SOC 2's Trust Services Criteria explicitly address risk areas like data confidentiality, availability, and processing integrity. Similarly, ISO 27001 requires organizations to implement an Information Security Management System (ISMS), with continuous risk assessment and mitigation. Keeping these processes up-to-date allows organizations to proactively address compliance gaps, thereby preventing fines, lawsuits, or data breaches.

Maintaining detailed compliance documentation helps organizations streamline their operations. Policies, standard operating procedures (SOPs), and checklists ensure that all employees follow uniform practices, minimizing inefficiencies and miscommunication. Furthermore, audits and reviews required for SOC 2 and ISO certifications promote continuous improvement, allowing organizations to refine their processes. Compliance documentation also simplifies onboarding new employees, vendors, and partners by clearly defining roles, responsibilities, and expectations. This standardization ensures smoother transitions and contributes to overall organizational stability. Non-compliance with SOC 2 and ISO standards can result in significant legal and financial consequences. Regulatory bodies impose fines, while customers may terminate contracts or file lawsuits in response to breaches. Maintaining compliance documents serves as a proactive measure to safeguard against such liabilities.

Additionally, thorough documentation provides evidence of due diligence during legal disputes. If a breach or incident occurs, compliance reports can demonstrate that the organization took reasonable steps to prevent it, potentially mitigating penalties and reputational harm. For organizations aiming to scale, compliance frameworks like SOC 2 and ISO provide a structured foundation for sustainable growth. Maintaining updated processes ensures that compliance efforts scale alongside the organization's expansion into new markets, regions, or service offerings. This is especially pertinent for businesses seeking to enter regulated industries or establish global partnerships. ISO certifications, for instance, are often prerequisites for collaborating with international organizations or bidding on government contracts. Having robust compliance documentation in place eliminates roadblocks to such opportunities, accelerating growth potential.

Audits are an integral part of compliance frameworks like SOC 2 and ISO standards. Generating and maintaining up-to-date compliance documents simplifies the audit process by ensuring all necessary evidence is readily available. This reduces the time, effort, and cost associated with external evaluations. Moreover, organizations that prioritize documentation can conduct internal audits more effectively, identifying and addressing weaknesses before external auditors are engaged. This proactive approach minimizes disruptions and demonstrates a culture of accountability and continuous improvement.

Generating and maintaining compliance documents and processes for regulations like SOC 2 and ISO standards is essential for building trust, mitigating risks, and achieving operational excellence. These efforts not only protect organizations from legal and financial liabilities but also enable them to thrive in competitive markets. By prioritizing compliance documentation, businesses signal their commitment to security, transparency, and continuous improvement, positioning themselves as reliable partners in an increasingly regulated world. Investing in these practices is not merely a regulatory obligation but a strategic asset that fosters resilience and growth.

Accordingly, there is a need for a software that can optimize compliance document generation and audit workflows to enable accurate and scalable compliance processes.

### SUMMARY OF THE INVENTION

It is the object of the present invention to provide a software application that automates management of compliance frameworks providing evidence documents for the frameworks wherein the method of the present invention includes the step of providing a questionnaire to obtain data specific to the user organization.

Another object of the present invention is to provide a method of managing compliance frameworks and providing automated generation of evidence documents to ensure compliance with the framework wherein the present invention includes a step of providing response guidelines to the questionnaire.

A further object of the present invention is to provide a software application that automates management of compliance frameworks providing evidence documents for the frameworks wherein the present invention further includes the step of tracking the progress for each framework.

Yet a further object of the present invention is to provide a method of managing compliance frameworks and providing automated generation of evidence documents to ensure compliance with the framework wherein the present invention includes cross mapping each required framework and utilizing redundant material to facilitate movement towards completion of the framework.

Still another object of the present invention is to provide a software application that automates management of compliance frameworks providing evidence documents for the frameworks wherein the present invention further includes providing a list of control request and selecting the control request for scope.

An additional object of the present invention is to provide a method of managing compliance frameworks and providing automated generation of evidence documents to ensure compliance with the framework wherein the present invention further includes the step of inputting the control references for a plurality of compliance frameworks.

Yet a further object of the present invention is to provide a software application that automates management of compliance frameworks providing evidence documents for the frameworks wherein the present invention further includes the step of generating an assessment report for a compliance framework.

An additional object of the present invention is to provide a method of managing compliance frameworks and providing automated generation of evidence documents to ensure compliance with the framework wherein the present invention utilizes artificial intelligence including but not limited to large language models, natural language processing and machine learning to accomplish the outputs of the present invention.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is an exemplary dashboard screenshot of the software application of the present invention; and

FIG. 2 is an exemplary questionnaire screenshot of the software application of the present invention; and

FIG. 3 is an exemplary controls screenshot of the software application of the present invention; and

FIG. 4 is a flowchart of the process of the present invention as facilitated by the software thereof.

### DETAILED DESCRIPTION

Referring now to the drawings submitted herewith, wherein various elements depicted therein are not necessarily drawn to scale and wherein through the views and figures like elements are referenced with identical reference numerals, there is illustrated a compliance process and document generation method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

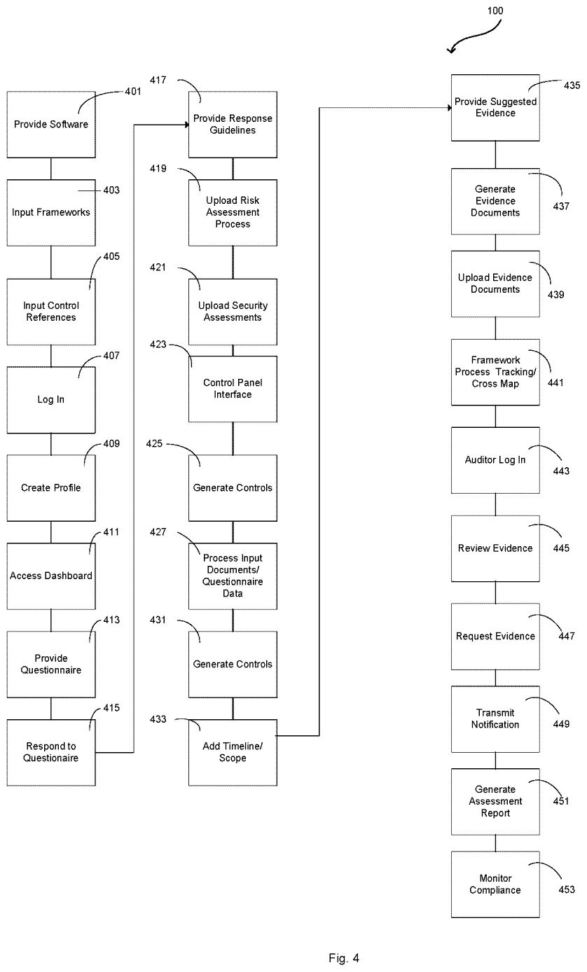

Referring in particular to the Figures submitted herewith, the compliance process and document generation method 100 utilizes a software application to provide execution and operation of the method of the present invention. It should be understood within the scope of the present invention that the present invention utilizes conventional computing equipment such as but not limited to database computers. The workflow illustrated herein in FIG. 4 should be understood to be exemplary and that the presented order of steps could be altered and/or have a portion thereof not executed or executed occasionally during use of the compliance process and document generation method 100.

Referring in particular to FIG. 4 submitted as a part hereof, the compliance process and document generation method 100 initiates in step 401 with an operator providing the software of the present invention to a user organization. Step 403, the compliance frameworks are input into the software wherein all compliance frameworks such as but not limited to SOC 2 are preloaded into the software application database. Step 405, all control references for each compliance framework loaded into the software application are input along with the requirements for each. It should be understood within the scope of the present invention that the software application has the aforementioned elements intrinsic as a part thereof prior to distribution or access to a user organization. In step 407, an individual within a user organization will log into the software application of the present invention. Step 409, the individual will create a profile wherein the profile contains conventional information and includes creation of username and passwords.

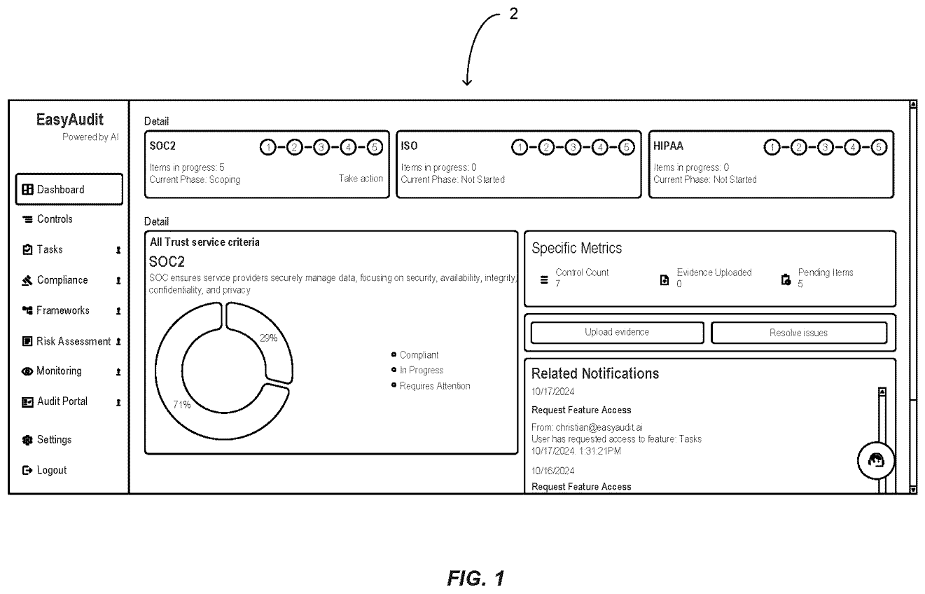

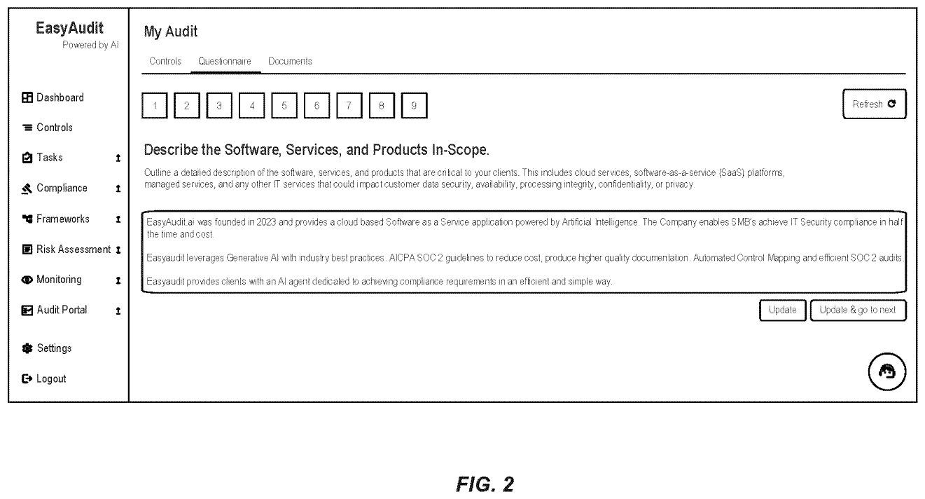

In step 411, the individual user will access the dashboard 2, illustrated herein in FIG. 1 submitted as a part hereof. The dashboard 2 of the software is a conventional dashboard that provides visibility and access to the operational features of the present invention. Step 413, the individual user is provided a questionnaire. The questionnaire is a detailed questionnaire that will provide input data into the software application with the required information about the user organization. FIG. 2 submitted as a part hereof provides an exemplary screenshot of a questionnaire graphical interface provided to the individual user. In a preferred embodiment of the present invention, the individual user is presented with nine questions wherein each question includes a plurality of sections. The questions are constructed to obtain the necessary information about the user organization in order to facilitate creation of compliance evidence required to be compliant with a selected compliance framework. By way of example but not limitation, the questionnaire can include requests for data on categories such as but not limited to current software platform utilized by the user organization, product information, infrastructure, employee structure, key service commitments, trust service criteria in scope for an audit and current risk assessment process.

Step 415, the individual of the user organization inputs responses to the questionnaire in order to facilitate the collection of the necessary data of the user organization for development of compliance frameworks and associated documents. In step 417, if needed the individual of the user organization can be provided with response guidelines to any of the questions or parts thereof. The software application upon request provides guidelines and sample data to each question in order to direct the individual of the user organization to enter the desired data. Step 419, if the user organization has a documented risk assessment process, the individual of the user organization will upload the risk assessment document into the software application. The software application will extract the data from the risk assessment document and utilize as needed for production of evidence documentation, suggested evidence production and other activities as required by the software. In step 421, if the user organization has documented security assessments, the individual of the user organization will upload the documents to be utilized by the software application similarly to the risk assessment documents.

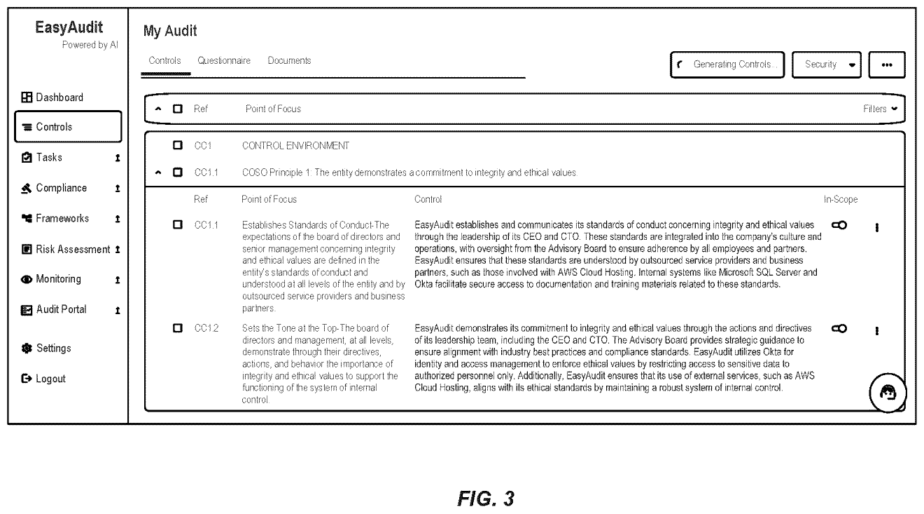

Step 423, the individual of the user organization will navigate to the control panel interface that is graphically presented to the individual in the software application. In step 425, the user will engage a generate controls icon to initiate the development of the controls for the desired frameworks. Step 427, the software application matches the input data from the questionnaires and uploaded documents with the input control references for each compliance framework. In step 431, the software application initiates and complete generation of the required controls that are needed to be fulfilled in order to be compliance with a compliance framework. FIG. 3 submitted as a part hereof provides an exemplary screenshot of the graphical interface provided for required controls in a particular compliance framework. Step 433, for each of the generated controls, if a required timeline for engagement therewith is required, the user of the individual can enter a timeline parameter. The timeline parameter provides a calendar term in which the software application will prompt the individual of the organization to take an action on the control such as but not limited to monitor or update progress thereon. Furthermore, the individual can select in scope or out of scope for each of the generated controls as certain conditions may allow exclusion of recommended controls for a compliance framework. In step 435, subsequent generation of controls, the software application will provide a list of suggested evidence that is required in order to successfully pass an audit on a compliance framework. It should be understood within the scope of the present invention that suggested evidence is documentation required by the requirements of the compliance framework. If in possession of the suggested evidence the individual of the user organization can upload into the software application for storage thereof permitting audit access thereto. Step 437, if a suggested evidence document is not currently created by the user organization, the software application is requested by the individual to generate the suggested evidence document required to be compliant with the compliance framework. The software application utilizes the input data from the questionnaire, control references and uploaded documents to provide production of the evidence documentation. In step 439, if the user organization is already in possession of the suggested evidence document, the user will upload the evidence document wherein the software application provides document management thereof.

In step. 441, the software application provides framework progress tracking and cross mapping to frameworks that have overlapping or redundant requirements. By way of example but not limitation, if the user organization has complied with the requirements of SOC 2, the software application will apply the overlapping requirements of ISO 27001 and display to the individual of the user organization what requirements of ISO27001 have been fulfilled by default through completion of SOC 2 requirements. Step 443, if an audit of the user organization is required, the software application provides an interface for an auditor to access the software application. In step 445, the auditor will review the evidence of the user organization for a particular compliance framework in order to ascertain compliance with the requirements. Step 447, if a deficiency is observed by the auditor, the auditor submits a request for additional evidence within the software application. In step 449, the software application will transmit a notification to the individual within the user organization wherein the notification is the request from the auditor for additional evidence or some issue related to the evidence documents provided in the software application for compliance with the compliance framework. Step 451, the individual of the user organization will request the software application to generate an assessment report for a selected compliance framework. The software application publishes the assessment report and provides document management thereof. In step 453, the software application provides monitoring of any required timelines for action on controls for a compliance framework and provides notification to the individual as to any actions that must be taken by the user organization.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A compliance progress tracking and document generation method wherein the method of the present invention comprises the steps of:
providing a software application, said software application configured to operate on a plurality of computing devices, said software application having as a part thereof a multitude of compliance frameworks, said software application having as a part thereof a control reference library, said control reference library consisting of all controls required for the compliance frameworks;
creating a profile, wherein an individual user of a user organization creates a profile for the user organization;
accessing a dashboard, said dashboard being graphically presented to the individual user allowing access to features of the software application;
providing a questionnaire, wherein the software application presents a questionnaire to the individual user, said questionnaire configured to request information about the user organization;
collecting data from the questionnaire, wherein the data from the questionnaire is stored in the software application;
uploading assessment documents, wherein the individual user will upload available assessment documents into the software application;
processing the assessment documents and the data;
generating a set of controls, wherein the set of controls are required by at least one compliance framework;
selecting a scope status for each control of the set of controls, wherein the individual user selects in scope or out of scope for the user organization for each control of the set of controls;
providing suggested evidence documents, wherein the software application provides documents needed to fulfill requirement of a control;
generating the evidence documents, wherein the software application provides generation of at least one evidence document for at least one control, wherein the at least one evidence document is printed and electronically stored;
monitoring progress of compliance with the compliance frameworks, wherein the dashboard of the software application provides a visible status of completion percentage of the compliance frameworks;
generating an assessment report, wherein the software application generates an assessment report for one of the compliance frameworks.

2. The compliance progress tracking and document generation method as recited in claim 1, and further including a step of cross referencing control completion of a first compliance framework to a second compliance framework, wherein the software application provides tracking and recording of redundant control completion across the compliance frameworks.

3. The compliance progress tracking and document generation method as recited in claim 2, and further including a step of providing a suggested response to a question in the questionnaire, wherein the software application provides input for data sought on the question.

4. The compliance progress tracking and document generation method as recited in claim 3, and further including a step of inviting a collaborator, wherein the individual user transmits an invitation utilizing the software application for assistance on input of data for the questionnaire.

5. The compliance progress tracking and document generation method as recited in claim 4, and further including a step of reviewing the evidence, wherein an auditor utilizes the software application to review the evidence of a set of controls within a compliance framework.

6. The compliance progress tracking and document generation method as recited in claim 5, and further including a step of requesting evidence, wherein the auditor utilizes the software application to request additional evidence for a control of a compliance framework.

7. The compliance progress tracking and document generation method as recited in claim 6, wherein the assessment documents are risk assessment or security assessment documents.

8. The compliance progress tracking and document generation method as recited in claim 7, and further including a step of adding a timeline to a control, wherein the software application will track a timeline in which the individual user must provide an update to the control.

9. The compliance progress tracking and document generation method as recited in claim 8, and further including a step of transmitting a notification, wherein the software application transmits a notification to the individual user regarding an audit inquiry or update requirement.

10. The compliance progress tracking and document generation method as recited in claim 9, and further including a step of providing a heat map, said heat map presenting areas of risk within a compliance framework.
